(19) United States
(12) Patent Application Publication
(10) Pub. No.: US 2010/0088387 A1
(43) Pub. Date: Apr. 8, 2010

(54) Email Notification Proxy

(75) Inventor: Pablo M. Calamera, San Jose, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/245,551

(22) Filed: Oct. 3, 2008

(51) Int. Cl. G06F 15/16; G06F 15/173

(52) U.S. Cl. 709/207; 709/224

(57) ABSTRACT

Among other things, techniques and systems are disclosed for exchanging notifications and data between a client device and a server. A system includes a server configured to maintain a first persistent connection to a mobile electronic device. The first persistent connection is configured to push at least service specific data to the mobile electronic device. The server is further configured to maintain a second persistent connection to a third party server. The second persistent connection is configured to monitor for availability, at the third party server, of new data associated with the mobile electronic device. The server is also configured to notify the mobile electronic device via the first persistent connection when new data becomes available at the third party server.

### TECHNICAL FIELD

This application relates to an email notification proxy that can be used, e.g., to deliver email messages from email servers to mobile electronic devices.

### BACKGROUND

Electronic mail, or email, is relied upon heavily for communications among people, both for business and personal purposes. Readily available access to new email messages has temporal and spatial aspects. From a temporal standpoint, readily available access refers to immediate, or nearly so, retrieval of new email messages by a recipient that retrieves correspondence using a computerized electronic device connected to the internet via the network infrastructure of an office or a home. From a location standpoint, readily available access refers to retrieval of new email messages when the recipient is remote from home or office and the recipient retrieves new email messages via a mobile electronic device. Furthermore, in order for access to be readily available according to the combination of temporal and spatial aspects, the recipient can immediately retrieve new email messages to remotely located mobile electronic devices.

### SUMMARY

Among other things, techniques and systems are disclosed for retrieving email messages between a mail client on a mobile electronic device and a mail server.

In one aspect, a system includes a main server configured to maintain a first persistent connection to a mobile electronic device. The first persistent connection is configured to push at east service specific data from the main server to the mobile electronic device. The main server is further configured to maintain a second persistent connection to a third party server. The second persistent connection is configured to monitor for availability, at the third party server, of new data associated with (e.g., for delivery to) the mobile electronic device. The main server also is configured to notify the mobile electronic device via the first persistent connection when new data becomes available at the third party server. In response, the mobile electronic device can then establish a temporary connection with the third party server to retrieve the associated data (e.g., an email message). The temporary connection is maintained only as long as needed to retrieve the data and then is terminated. In an implementation, the main server can be regarded as an “in-service” server and the third party server can be regarded as an “outside-service” server.

In another aspect, a method implemented as an internet-based service, includes maintaining a first persistent connection from a main server to a mobile electronic device. The first persistent connection is configured to push at least service specific data to the mobile electronic device. The method further contains maintaining a second persistent connection from the main server to a third party server. The second persistent connection is configured to monitor for availability, at the third party server, of new data associated with the mobile electronic device. Another aspect of the method includes notifying the mobile electronic device via the first persistent connection when new data becomes available at the third party server.

In yet another aspect, a system includes an internet-based server. The internet-based server is communicatively coupled with one or more portable electronic devices via a notification push channel, configured to push notifications related to a service account associated with the one or more portable electronic devices. The internet-based server is further communicatively coupled with an IMAP email provider via a communication channel based on IMAP idle, configured to monitor an email account associated with the one or more portable electronic devices, for new email notifications. The internet-based server is also configured to relay the new email notifications to the one or more portable electronic device via the notification push channel upon receipt of a new-email notification from the internet-based server. The new-email notification triggers any of the one or more portable electronic devices to connect to the IMAP email provider via the communication channel based on IMAP idle to retrieve new email messages.

In another aspect, a method implemented at an internet-based server, includes monitoring, via a communication channel based on IMAP idle, new email notifications from an IMAP email provider. The email messages are associated with one or more portable electronic devices. The method also includes broadcasting to the one or more portable electronic devices, via a notification push channel, a new email notification received from the IMAP email provider. The broadcasting prompts any one of the plurality of portable electronic devices to connect to the IMAP email provider and retrieve new email messages.

In another aspect, a computer implemented method includes providing a proxy service to a mail server. The method also includes receiving a connection from a mail client to the proxy service, then releasing the connection from the mail client. The method further includes continuingly retrieving information from the mail server via the proxy service for the mail client. The method includes pushing the information via the proxy service to the mail client.

The subject matter described in this specification can be implemented as a method or as a system or using computer program products, tangibly embodied in information carriers, such as a CD-ROM, a DVD-ROM, a HD-DVD-ROM, a Blue-Ray drive, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

Certain implementations may provide various advantages. For example, battery lifetime and network efficiency are particularly important to mobile electronic devices, for example, cell phones. The email notification proxy described in this specification enables users of mobile electronic devices to offload the task of monitoring for availability of new-email messages at email servers, thus minimizing battery and communication bandwidth consumption of mobile electronic devices. The email notification proxy also facilitates persistent connections effectively between a mobile electronic device and one or more third party email services. Other features, objects, and potential advantages of the subject matter of this specification will be apparent from the description and drawings, and from the claims.

### BRIEF DESCRIPTION OF THE DRAWINGS

FIG. 1 is a block diagram showing a portable electronic device in communication with a main server and with an email server.

FIGS. 2(a)-(b) are block diagrams showing a main server in communication with a portable electronic device and with an email server.

FIG. 2(c) is a block diagram showing a service server, a portable electronic device and an email server in communication with each other.

FIG. 3 is a block diagram of a main server in communication with a portable electronic device and with an email server.

FIG. 4 shows a swim-lane diagram of a system including a service server, a portable electronic device and an email server in communication with each other.

FIGS. 5-6 represent aspects of a method implemented at a main server to notify a portable electronic device of new email messages at an email server.

FIG. 7 is a schematic of a computerized electronic device.

Like reference symbols and designations in the various drawings indicate like elements.

### DETAILED DESCRIPTION

Techniques and systems are disclosed for enabling offloading of persistent wireless connections from a mail client to a mail server, specifically when the mail client is a mobile electronic device.

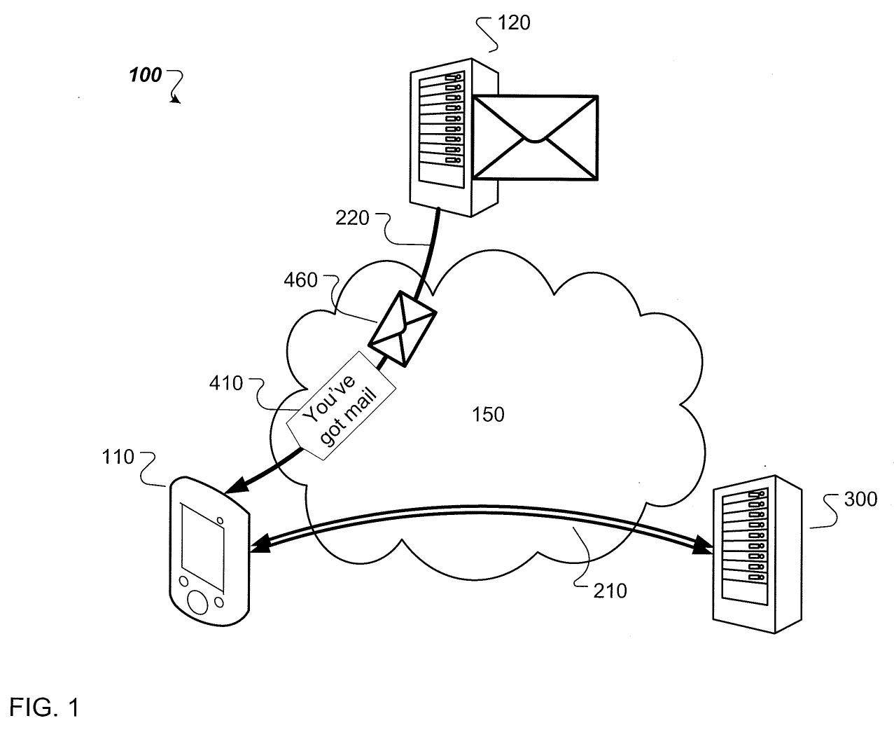

A communication system 100 as depicted in FIG. 1 refers to a mobile electronic device in communication with an internet-based service provider and an internet-based email provider. A mobile electronic device 10 may be connected to the internet 150 via a mobile communication network. Throughout this document, the mobile communication network is assumed to be wireless. Furthermore, the mobile communication network can allow for voice and data communications. Voice communications, for example using the GSM protocol, can include SMS messaging. The data communication bandwidth can be, for example, 2.5 G or 3 G, WiMax and Wi-Fi. Thus, a multitude of information can be exchanged over the data channel, such as text, pictures, music, video, live TV, and multimedia.

The mobile electronic device 10 can be a smart phone, such as the Iphone, or any other mobile phone, a digital music player, for example Ipod, a personal digital assistant (PDA), a laptop or any other computerized electronic device that can be connected to a mobile network. The mobile electronic device can connect to the internet-based service provider 300 via a communication channel 210, and one or more internet-based email providers 120 via communication channels 220. The communication channels 210 and 220 can transmit voice or data, as described above.

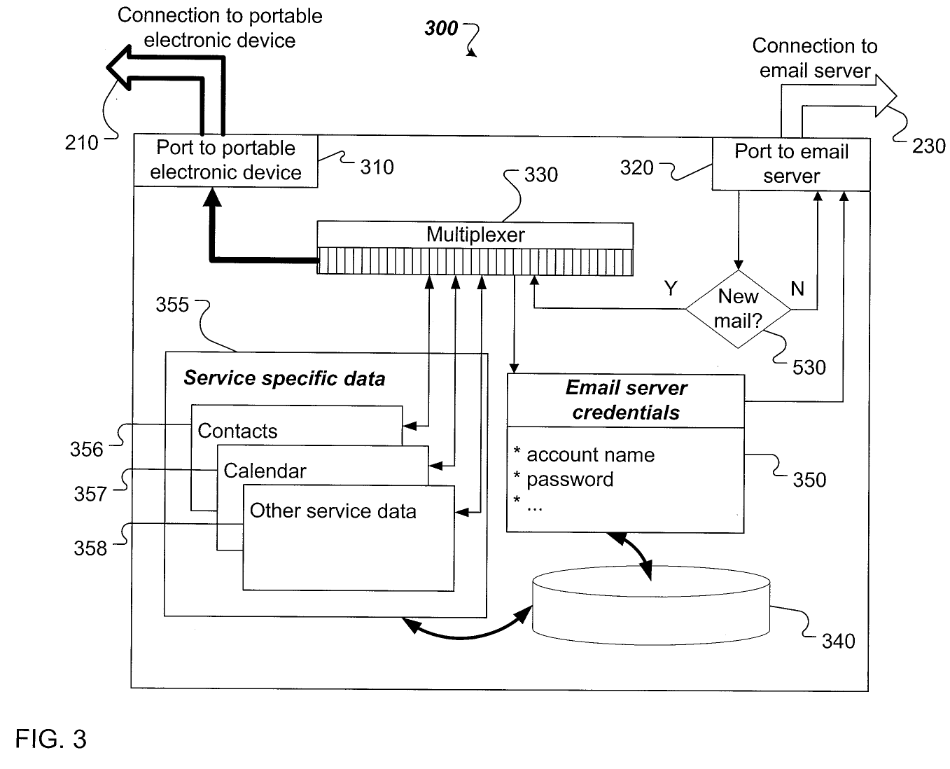

The internet-based service provider includes a main server 300. Throughout this document, the main server 300 is also referred to as the in-service server or the internet based service. The internet-based service, also known as cloud-service, can be, for example, Apple's Mobile Me. The internet-based service allows subscribers to associate one or more mobile electronic devices 110 with a service account. The internet-based service is configured, among other things, to synchronize the multiple mobile electronic devices 110 (associated with the service account) with respect to changes of calendar or contacts information related to the service account. Other aspects of the service account are described later, with respect to FIG. 3. The main server 300 pushes to the mobile electronic device 110, through the communication channel 210, notifications of calendar and contacts changes associated with the service account.

Returning to FIG. 1, the internet-based email provider includes an email server 120. Throughout this document, the email server 120 is also referred to as the third party server, or simply the email provider. The email provider can be, for example, GMAIL, Yahoo! Mail, AOL, Cyrus MAIL, or many other commercial or open source internet-based email providers. The third party server 120 can also be part of a corporate mail system. Subscribers have email accounts with the internet-based email provider. An email account is accessible from a browser-based interface on a computerized electronic device, such as a mobile electronic device 110. The mobile electronic device 110 associated with the email account connects to the email server 120 through the communication channel 220.

In one implementation, the internet-based email provider is configured according to the Internet Message Access Protocol (IMAP4), based on standards developed by the Internet Engineering Task Force (IETF). In the IMAP implementation, the email server 120 is also referred to, interchangeably, as the IMAP server. If the email server 120 is configured according to IMAP4, the IDLE extension (or command) is applicable to the communication channel 220. IMAP4 IDLE allows the mobile electronic device 110 to maintain a connection with the IMAP server 120 without having to poll for availability of new email messages at the IMAP server 120. In fact, once a new email message arrives at the IMAP server 120, it is the IMAP server 120 which transmits a new-email notification 410 to the mobile electronic device 110 through the IMAP4 IDLE enabled connection 220. Then, the mobile electronic device 110 can issue a FETCH command to retrieve the newly available email message 460. In another implementation, the email server may be configured according to the post office protocol (POP3).

Maintaining an active IMAP IDLE connection 220 with one or more IMAP servers 120 can be burdensome on the operational resources available to the mobile electronic device 110. Specifically, the power consumption to actively maintain such connections 220 can be significant, and can lead to rapid battery drain. At the same time, the bandwidth necessary to actively maintain the connections 220 can hinder bandwidth utilization for other active connections of the mobile electronic device 110, for example the communication channel 210 to the internet-based service 300. The techniques and systems disclosed in this document offload the task of maintaining active connections 220 from the mobile electronic device 110 to the main server 300.

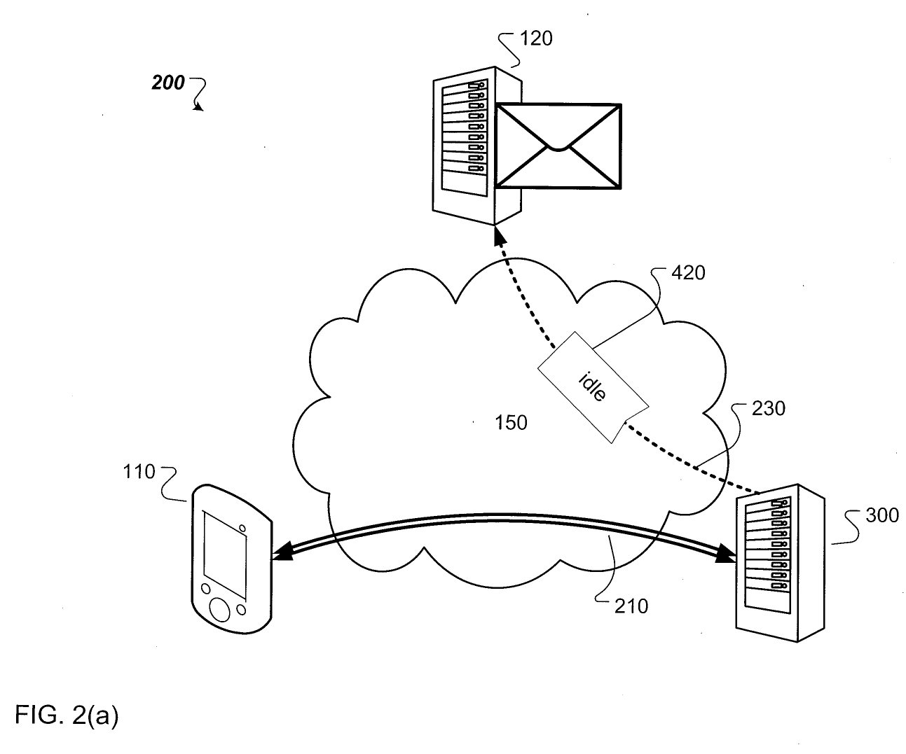

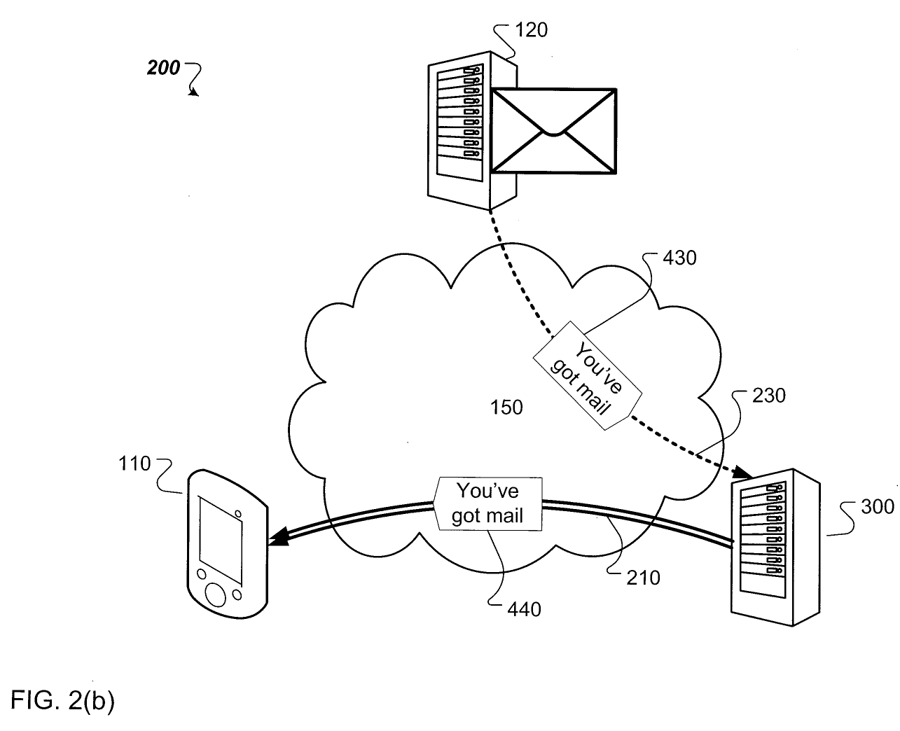

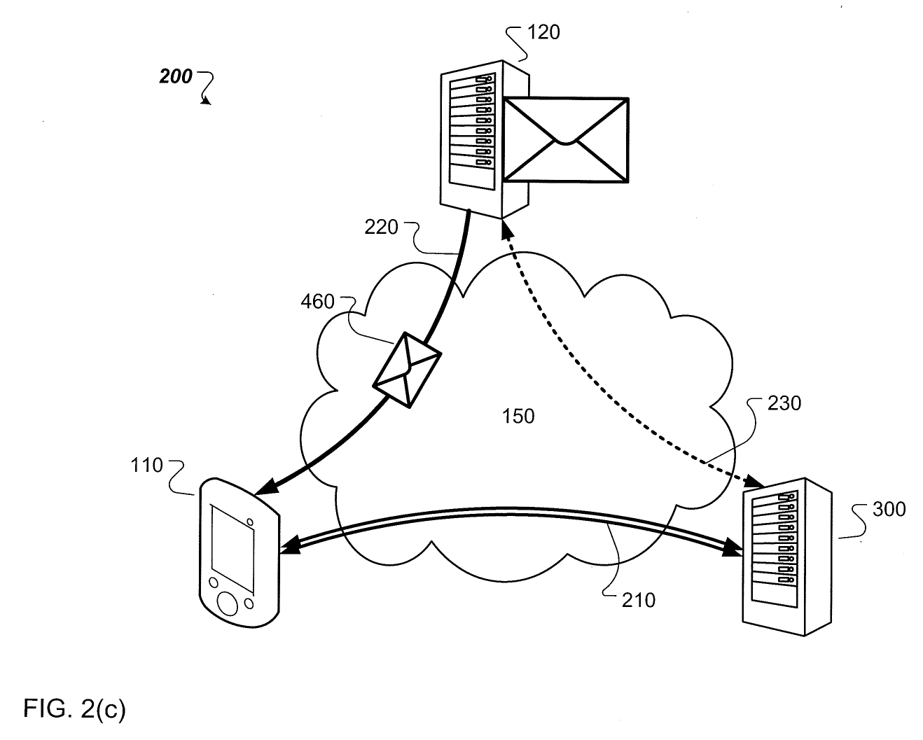

The communication system 200 as depicted in FIGS. 2(a-c) refers to a main server 300 in communication with a mobile electronic device 110 and a third party server 120. The main server 300 communicates with the mobile electronic device 110 via the communication channel 210 as described above. From the perspective of the internet-based service provider, the communication channel 210 is also referred to as the first persistent connection 210.

The third party server 120 is part of an internet-based email provider and is configured with IMAP4, including the IDLE extension. As shown in FIG. 2(a), the main server 300 maintains an active connection 230 with the IMAP server 120. Based on previously transferred email account credentials associated with the mobile electronic device 110, the main server 300 monitors the IMAP4 IDLE enabled communication channel 230 for new-email notifications. Extrapolating the first persistent connection terminology introduced above to describe connection 210 between the main server 300 and the mobile electronic device 110, the communication channel 230 between the main server 300 and the third-party server 120 is referred to as the second persistent connection 230.

Note that because the main server 300 acts as a proxy for the mobile electronic device 110, the direct connection 220 from the mobile electronic device 110 to the IMAP server 120 can be dropped. By not having to maintain direct connections to one or more email servers 120, the mobile electronic device 110 benefits from longer battery life and communication bandwidth efficiency.

FIG. 2(b) shows an instance when the main server 300 receives a new-email notification 430 from the IMAP server 120 through the IMAP4 IDLE enabled communication channel 230. Upon receipt of the new-email notification 430, the main server 300 multiplexes, alongside with other data types exchanged via the data pipe 210, a new-email notification 440 for transmission to the mobile electronic device 110. Once the mobile electronic device 110 receives the new-email notification 440 transmitted through the active connection 210 from the main server 300, the mobile electronic device 110 can connect directly to the mail server 120 to retrieve the newly received email. Note that the mobile electronic device 110 has received notification of newly received email without maintaining an active connection 220 directly with the IMAP server 120.

FIG. 2(c) depicts an instance when the mobile electronic device 110 is connected to the IMAP server 120 via the direct communication link 220. The newly arrived email 460 is fetched from the IMAP server 120 by the mobile electronic device 110. Once the email 460 has been retrieved by the mobile electronic device 110, the direct connection 220 is dropped in order to preserve power and network resources at the mobile electronic device 110. Meanwhile, the main server 300 maintains active both the first persistent connection 210 with the mobile electronic device 110 and the second persistent connection 230 with the IMAP server 120.

The components and subsystems that enable the main server 300 to handle the tasks of (1) maintaining in-service and outside-service connectivity, and (2) manage service specific data are illustrated diagrammatically in FIG. 3.

The main server 300 includes, among other things, a data repository 340 to store service specific data 355. The service specific data 355 includes contacts 356, calendar 357 and other service data 358. The other service data 358 may include, in one implementation, a picture gallery, backup data, etc.

A multiplexer 330 combines different types of service specific data 355 for transmittal to at least one portable electronic device 110 associated with a service account. The multiplexed data is sent to the communication pipe 210 which connects the main server to the mobile electronic device 110 via the port 310. At the same time, data uploaded from the mobile electronic device 110 via the communication channel 210 enters the main server 300 through port 310. Data incoming from the mobile electronic device 110 is de-multiplexed into the appropriate service specific data 355 category 356-358 by the multiplexer 330.

Data uploaded from the mobile electronic device 110 includes email server credentials 350 for the email account at the IMAP server 120 associated with the mobile electronic device 110. The email server credentials 350 include an account name, password, etc. Data referring to the email server credentials can be stored in the data repository 340 or in another dedicated storage element at the main server 300.

The email server credentials 350 associated with the mobile electronic device 110 are used by the main server 300 to connect to the IMAP server 120. Specifically, the email server credentials are sent via the port 320 to the IMAP server 120 to establish the IMAP4 IDLE enabled second persistent connection 230 between the main server 300 and the IMAP server 120.

When a new-email notification 430 arrives from the IMAP server 120 to the main server 300 via the port 320, a listener element 530 routes the new-email notification 430 to the multiplexer 330. The multiplexer 330 combines the new-email notification 430 with other service specific data 355 or notifications for transmittal to the mobile electronic device 110. Thus, a new-email notification 440 can be submitted to the mobile electronic device 110 through the active first persistent connection 210.

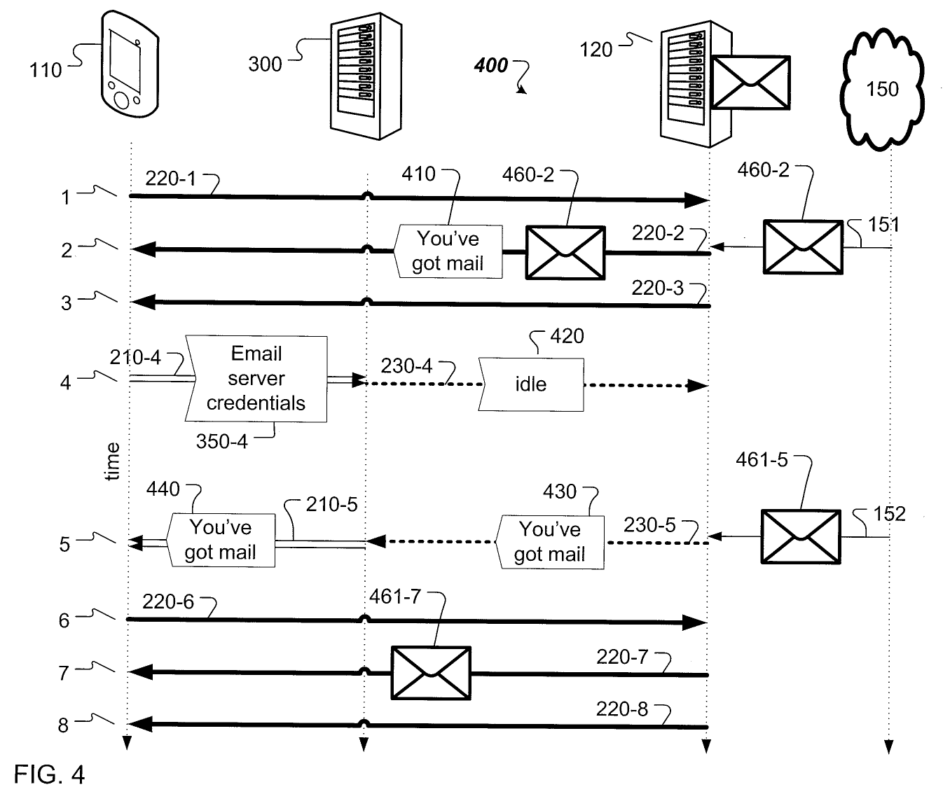

The swim-lane diagram 400 in FIG. 4 illustrates the IMAP proxy technique as a time sequence from time 1 (at the top of diagram 400) to time 8 (at the bottom of diagram 400). The first or left-most (vertical) lane signifies the time sequence corresponding to the mobile electronic device 110. The second lane corresponds to the time sequence of the main server 300. The third lane depicts the time sequence of the IMAP server 120. Finally, the fourth (right-most) lane corresponds to the internet 150 (as a whole). The fourth lane represents an input for diagram 400, i.e., email messages arrive into diagram 400 from the internet 150.

At time 1, a subscriber of the internet-based email provider connects to the IMAP server 120 using a mobile electronic device 110, via a direct connection 220. The index “-j”, hyphenated to any label denotes a time instance of that element. In FIG. 4, for example, connection label 220-1, stands for connection 220 at time 1, and so on. As indicated earlier, connection 220 between the mobile electronic device 110 and the IMAP server 120 is IMAP4 IDLE enabled.

At time 2, a new email 460-2 addressed to the mobile electronic device 110 arrives at the IMAP server 120. The IMAP server 120 receives the newly arrived email 460-2 through an internet connection 151. The IMAP server 120 first submits a new-email notification 410 to the mobile electronic device 110 through the direct connection 220-2. Shortly after that, upon a FETCH command (not illustrated) from the mobile electronic device 110, the IMAP server 120 transmits the newly arrived email 460-2 to the mobile electronic device 110. Time instance 2 of the swim-lane diagram 400 corresponds to the system configuration and state illustrated in FIG. 1.

At time 3, the mobile electronic device 110 submits a DISCONNECT command through connection 220-3 and disconnects from the IMAP server 120. By doing so, the mobile electronic device 110 cannot receive future new-email notifications from the IMAP server, until at a later time when the two entities re-establish connection 220.

During the “off-line state” (with respect to the email provider) of the mobile electronic device 110, the main server 300 can act as a proxy to monitor new-email notifications at the IMAP server 120 on behalf of the mobile electronic device 110. As explained earlier, the first persistent connection 210-4 associated with the service account of the mobile electronic device 110 is assumed to be active all the time. Therefore, at time 4, the mobile electronic device 110 uploads the email server credentials 350-4 to the main server 300.

Using the newly uploaded email server credentials 350-4, the main server 300 establishes an out-of service connection 230-4 with the IMAP server 120. As discussed earlier, the second persistent connection 230-4 is IMAP4 IDLE enabled. From time 4 on, the main server 300 serves as an IMAP-proxy on behalf of the mobile electronic device 110. Note, that the mobile electronic device 110 has been and remained disconnected from the direct connection 220 to the IMAP server 120 since time 3. Time instance 4 of the swim-lane diagram 400 corresponds to the system configuration and state illustrated in FIG. 2(a).

Returning to FIG. 4, at time 5, another email 461-5 addressed to the mobile electronic device 110 arrives at the IMAP server 120. The IMAP server 120 receives the newly arrived email 461-5 through another internet connection 152. The IMAP server 120 submits a new-email notification 430 to the main server 300 through the active second persistent connection 230-5. Upon receipt of the new-email notification 430, the main server 300 multiplexes a new-email notification 440 alongside other service specific data 355 for transmission through the first persistent connection 210-5. Therefore, the mobile electronic device 110 can find out substantially immediately about the arrival of new email 461-5, without being directly connected to the IMAP server 120. Time instance 5 of the swim-lane diagram 400 corresponds to the system configuration and state illustrated in FIG. 2(b).

Returning to FIG. 4, at time 6, the mobile electronic device 110 may decide to directly connect to the IMAP server 120, by reestablishing the connection 220-6, in order to retrieve the newly arrived email 461. Once the second persistent connection 230 was established at time 4 between the main server 300 and the IMAP server 120, the newly reestablished connection 220 is referred to as the temporary connection 220.

Upon establishing the temporary connection 220-6, the mobile electronic device 110 issues a FETCH command (not illustrated) to the IMAP server 120. At time 7, the IMAP server transmits the email 461-6 to the mobile electronic device 110. Time instance 7 of the swim-lane diagram 400 corresponds to the system configuration and state illustrated in FIG. 2(c).

Returning to FIG. 4, at time 8, once the latest email 461 has been retrieved, the mobile electronic device 110 submits a DISCONNECT command through the temporary connection 220-8 and disconnects from the IMAP server 120. Again, the mobile electronic device 110 cannot receive future new-email notifications from the IMAP server 120, until at a later time the two entities re-establish a temporary connection 220. On the other hand, the mobile electronic device 110 has again offloaded to the main server 300 the burdensome task of maintaining additional direct connections with the mail server 120. The proxy technique can be accomplished as shown in diagram 400 because the first persistent connection 210 and the second persistent connection, both associated with the service account of the mobile electronic device 110, are kept active all the time by the main server 300.

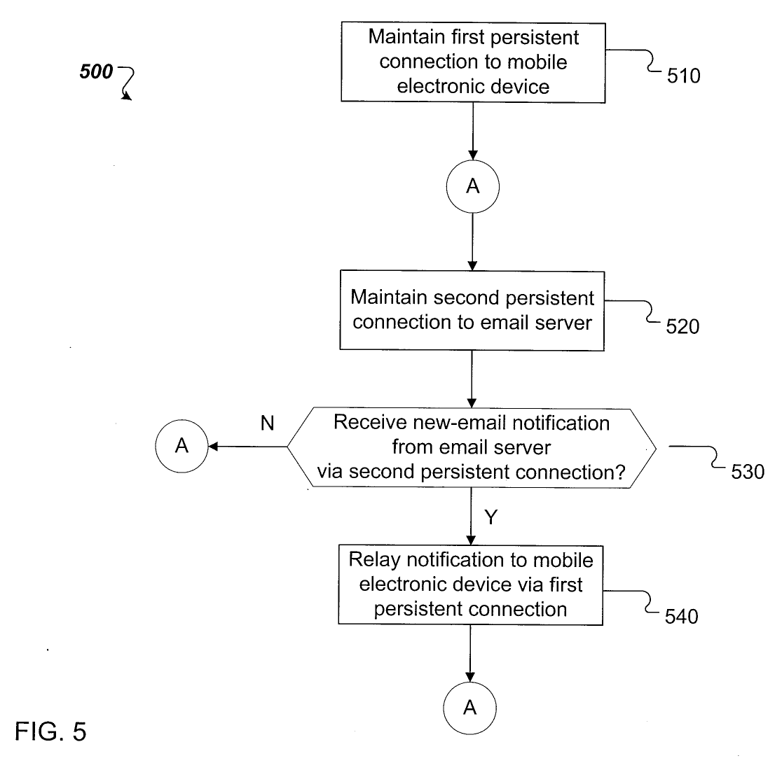

The method 500 disclosed in this document is summarized in the flow chart diagram of FIG. 5. The method 500 can be implemented at a service server. At step 510, the main server maintains a first persistent connection to a mobile electronic device. This first persistent connection can be stateless, i.e. the first persistent connection is always active. The vertex A represents a looping point for method 500 as shown below.

At step 520 the main server also maintains a second persistent connection to an email server. The second persistent connection can also be stateless, i.e. the second persistent connection remains active once established.

At step conditional step 530, the main server monitors the second persistent connection for a new-email notification associated with the mobile electronic device from the email server. While no new-email notification is received at the service server, the monitoring state corresponding to step 520 continues, and method 500 loops back to vertex A.

At step 540, upon receipt of a new-email notification from the email server, the main server submits a notification to the mobile electronic device via the active first persistent connection. Then, method 500 loops back to vertex A and steps 530 and 540 are executed for as long as necessary.

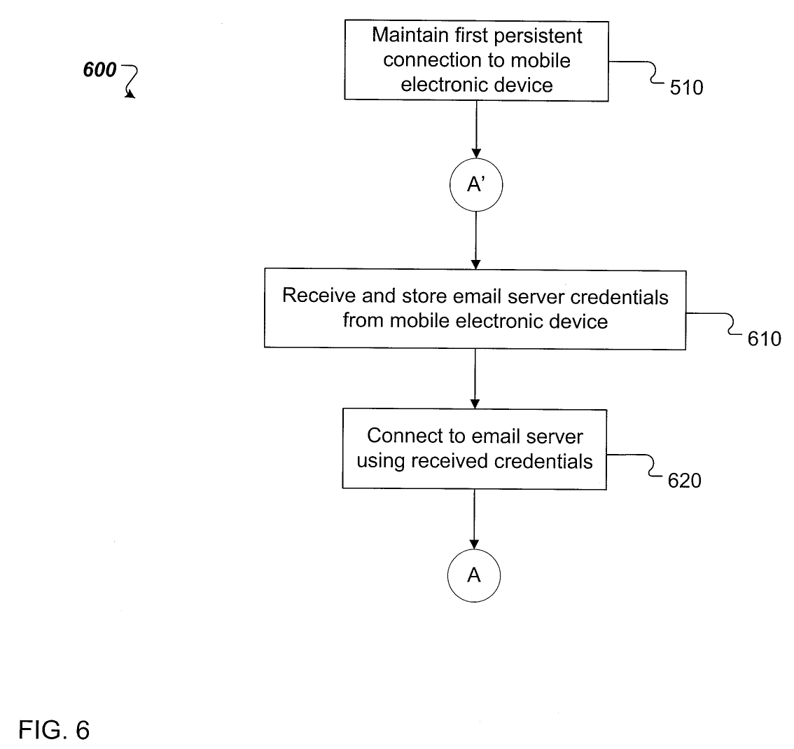

FIG. 6 illustrates a portion 600 of method 500. Portion 600, between vertex A′ and vertex A, relates to establishing, by the service server, the second persistent connection with the email server. At step 610, the main server receives from the mobile electronic device the email server credentials associated with the mobile electronic device. At this step, the main server also stores locally the email server credentials.

At step 620, the main server connects to the email server using the received email server credentials. By doing so, the main server establishes the second persistent connection with the email server.

In another aspect, the technique 500 can be implemented at the main server to broadcast the new-email notification from the IMAP email server to one or more mobile electronic devices associated with the service account. For example, step 510 can be modified to indicate that the main server maintains one or more first persistent connections to respectively one or more mobile electronic devices. Then, step 540 can be modified to indicate that, upon receipt of a new email notification from the email server, the main server broadcasts a notification to one or more mobile electronic device via the respectively one or more active first persistent connections.

In yet another aspect, the technique 500 can be implemented at the main server to monitor one or more IMAP email servers. For example, step 520 can be modified to indicate that the main server maintains one or more second persistent connections to respectively one or more IMAP email servers. Then, step 530 can be modified to indicate that the main server monitors the one or more second persistent connections for a new-email notification associated with the mobile electronic device from the respectively one or more email servers.

Additionally, the technique 500 can be implemented at the main server to monitor one or more IMAP email servers and to broadcast a new-email message notification to at least one mobile electronic device. For example, step 520 can be modified to indicate that the main server maintains one or more second persistent connections to respectively one or more IMAP email servers. Then, step 530 can be modified to indicate that the main server monitors the one or more second persistent connections for a new-email notification associated with the at least one mobile electronic device from the respectively one or more email servers. Next, step 540 can be modified to indicate that, upon receipt of a new email notification from any of the one or more email servers, the main server broadcasts a notification to the at least one mobile electronic device via the respectively one or more active first persistent connections.

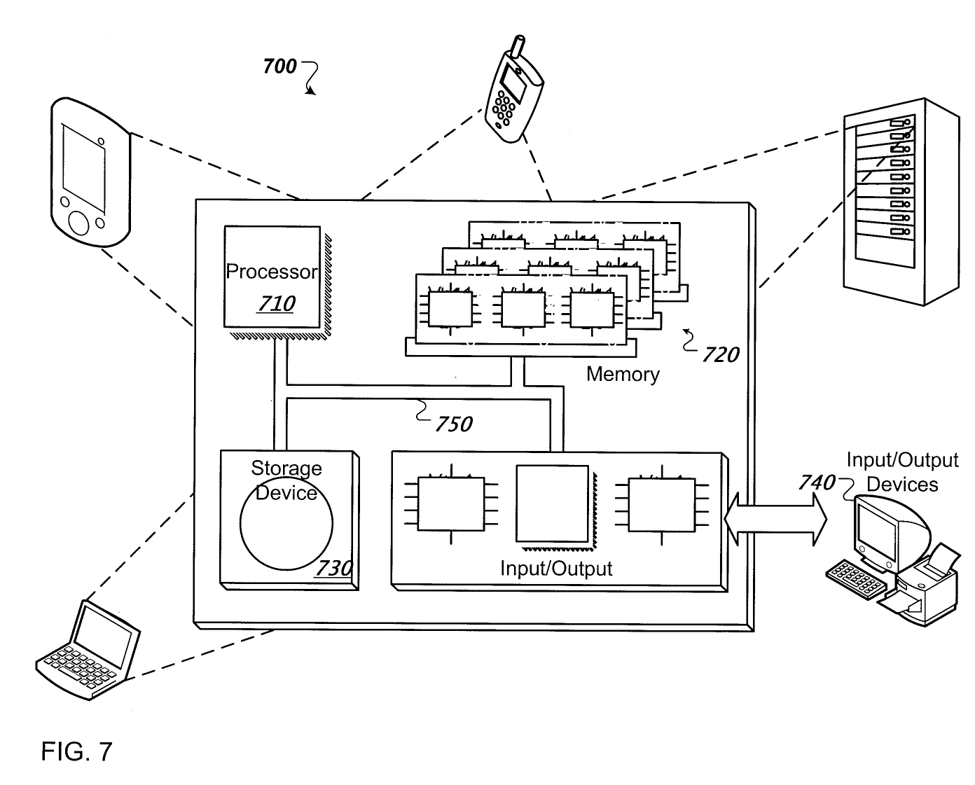

FIG. 7 is a schematic diagram of a computer system 700 representing the main server 300. Also the computer system 700 can represent the email server 120. Further, the computer system 700 can represent the portable electronic device 110. The system 700 can be used for the operations described in association with any of the computer-implement methods described previously, according to one implementation. The system 700 is intended to include various forms of digital computers, such as laptops, desktops, workstations, servers, blade servers, mainframes, and other appropriate computers. The system 700 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

Aspects of the subject matter and the functional operations described in this specification can be implemented in digital electronic circuitry, or in computer software, firmware, or hardware, including the structures disclosed in this specification and their structural equivalents, or in combinations of one or more of them. Aspects of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, a portable electronic device, a server, or multiple processors, portable electronic devices and servers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular implementations of particular aspects. Certain features that are described in this specification in the context of separate aspects can also be implemented in combination in a single aspect. Conversely, various features that are described in the context of a single aspect can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Only a few implementations and examples are described and other implementations, enhancements and variations can be made based on what is described and illustrated in this application.

What is claimed is:

1. A system comprising:
a server configured to:
maintain a first persistent connection to a mobile electronic device, wherein the first persistent connection is configured to push at least service specific data to the mobile electronic device;
maintain a second persistent connection to a third party server, wherein the second persistent connection is configured to monitor for availability, at the third party server, of new data associated with the mobile electronic device; and
notify the mobile electronic device via the first persistent connection when new data associated with the mobile electronic device becomes available at the third party server.

2. The system of claim 1, wherein the server is further configured to cause the mobile electronic device to establish a temporary connection directly to the third party service, the temporary connection being maintained sufficiently long to retrieve the new data associated with the mobile electronic device.

3. The system of claim 1, wherein the first persistent connection comprises a data channel or a voice channel.

4. The system of claim 3, wherein the data channel comprises Apple's Notification Service.

5. The system of claim 3, wherein a notification through the voice channel comprises an SMS message.

6. The system of claim 1, wherein the service specific data comprises contacts and calendar information.

7. The system of claim 1, wherein the portable electronic device comprises one or more of a smart phone, a cellular phone, a personal digital assistant and a laptop.

8. The system of claim 1, wherein an association between the server and the mobile electronic device comprises a service account.

9. The system of claim 8, wherein the service account comprises Apple's Mobile Me.

10. The system of claim 8, wherein the third party server comprises an email service provider including personal mail or corporate mail.

11. The system of claim 10, wherein the second persistent connection includes IMAP and the IMAP idle extension.

12. The system of claim 10, wherein the new data comprises new email messages.

13. The system of claim 10, wherein the service account includes authentication information for an email account at the email service provider, the email account associated with the portable electronic device.

14. A method implemented as an internet-based service, the method comprising:
maintaining a first persistent connection from a main server to a mobile electronic device, wherein the first persistent connection is configured to push at least service specific data to the mobile electronic device;
maintaining a second persistent connection from the main server to a third party server, wherein the second persistent connection is configured to monitor for availability, at the third party server, of new data associated with the mobile electronic device; and
notifying the mobile electronic device via the first persistent connection when new data becomes available at the third party server.

15. The method of claim 14, wherein notifying the mobile electronic device comprises causing the mobile electronic device to establish a temporary connection directly to the third party service, the temporary connection being maintained sufficient long to retrieve the new data associated with the mobile electronic device.

16. The method of claim 15, wherein the third party server comprises an email service provider including personal mail or corporate mail.

17. The method of claim 15, wherein an association between the internet-based service and the mobile electronic device comprises a service account.

18. The method of claim 17, wherein the service account includes authentication information for an email account at the email service provider, the email account being associated with the portable electronic device.

19. The method of claim 16, wherein the second persistent connection includes IMAP and the IMAP idle extension.

20. A system comprising:
an internet-based server:
communicatively coupled with one or more portable electronic devices via a notification push channel, configured to push notifications related to a service account associated with the one or more portable electronic devices;
communicatively coupled with an IMAP email provider via a communication channel based on IMAP idle, configured to monitor an email account associated with the one or more portable electronic devices, for new email notifications; and
configured to relay the new email notifications to the one or more portable electronic device via the notification push channel upon receipt of a new email notification from the internet-based server, to trigger any of the one or more portable electronic devices to connect to the IMAP email provider via the communication channel based on IMAP idle to retrieve new email messages.

21. The system of claim 20, wherein the plurality of portable electronic devices comprises a smart phone, a cellular phone, a personal digital assistant and a laptop.

22. The system of claim 20, wherein the IMAP email provider comprises any IMAP compliant server that supports IMAP idle.

23. The system of claim 22, wherein the IMAP email provider comprises GMAIL, Yahoo! mail, AOL, and Cyrus mail.

24. The system of claim 20, wherein the notifications related to the service account associated with the plurality of portable electronic devices comprise contacts and calendar notifications.

25. The system of claim 20, wherein authentication information for the email account associated with the plurality of portable electronic devices and based at the IMAP email provider is stored on each one of the plurality of portable electronic devices and on the internet-based server.

26. A method implemented at an internet-based server, the method comprising:
monitoring, via a communication channel based on IMAP idle, new email notifications from an IMAP email provider, wherein email messages are associated with one or more portable electronic devices; and
broadcasting to the one or more portable electronic devices, via a notification push channel, a new email notification received from the IMAP email provider to prompt any one of the plurality of portable electronic devices to connect to the IMAP email provider and retrieve new email messages.

27. A computer implemented method comprising:
providing a proxy service to a mail server;
receiving a connection from a mail client to the proxy service;
releasing the connection from the mail client;
continuingly retrieving information from the mail server via the proxy service for the mail client; and
pushing the information via the proxy service to the mail client.

28. The method of claim 27, wherein the mail server comprises an IMAP server.

29. The method of claim 27, wherein the proxy service is implemented on a server distinct from the mail client or the mail server.
